(19) United States
(12) Patent Application Publication
(10) Pub. No.: US 2007/0096882 A1
(43) Pub. Date: May 3, 2007

(54) Sensor based selection of radio frequency identification tags

(75) Inventors: William R. Bandy, Gambrills, MD (US); Kevin J. Powell, Annapolis, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/263,990

(22) Filed: Nov. 2, 2005

(51) Int. Cl. H04Q 5/22

(52) U.S. Cl. 340/10.51; 340/572.3

(57) ABSTRACT

Methods, systems, and apparatuses for interacting with radio frequency identification (RFID) tags are described. A tag selector stimulates a sensor of a tag to enable a tag. A tag processor interacts with the enabled tag. The tag processor can test, program, kill, and/or otherwise interact with the tag, while enabled. In this manner large numbers of tags can be interacted with in close proximity, such as during their manufacture in a web format, because the tag selector enables a selected tag (or tags) at any one time.

### BACKGROUND OF THE INVENTION

1. Field of the Invention

The present invention relates to the testing and programming of radio frequency identification (RFID) tag devices.

2. Background Art

Radio frequency identification (RFID) tags are electronic devices that may be affixed to items whose presence is to be detected and/or monitored.

The presence of an RFID tag, and therefore the presence of the item to which the tag is affixed, may be checked and monitored by devices known as “readers.” Readers typically transmit radio frequency signals to which the tags respond. Each tag can store a unique identification number. The tags respond to the reader transmitted signals by providing their identification number, bit-by-bit, so that they can be identified.

Tags are typically programmed and tested for proper performance prior to being sold. Future demand for RFID tags is estimated to be for over a billion tags a year. Having an accurate high-speed programming and test system that can support such volume is extremely critical. Currently, programming and test systems that can rapidly and reliably handle large volumes of tags do not exist. Current systems are extremely difficult to control and are reaching their limits in terms of the volume of tags that can be reliably programmed and tested.

Such systems can suffer from a variety of problems. For example, systems using radiated test signals sometimes unintentionally read adjacent tags, and thus have difficulty identifying a specific “bad” tag from a group of tags.

Furthermore, tags are susceptible to tampering by unauthorized sources. For example, an unauthorized source may attempt to read tags, re-program tags, or even “kill” tags, surreptitiously, by communicating with the tags.

Thus, what is needed are RFID tag programming and testing schemes which can handle very large volumes of tags, and can program and test the tags rapidly, in a reliable, secure, and repeatable fashion.

### BRIEF SUMMARY OF THE INVENTION

Methods, systems, and apparatuses for selecting radio frequency identification (RFID) tags are described. In aspects of the present invention, a desired tag may be selected for interaction from a group of tags. The selection of a tag enables the interrogating, programming, testing, and/or other processing or operating on the tag, without interference from others of the nearby tags.

In an example aspect, a radio frequency identification (RFID) tag includes a substrate, an antenna on the substrate, an integrated circuit (IC) die mounted to the substrate, and a sensor that when stimulated enables a function of the tag.

In a further example aspect, a tag selector stimulates a sensor of the tag to enable a tag. A tag processor interacts with the enabled tag. The tag processor can test, program, and/or otherwise interact with the tag, while enabled. In this manner large numbers of tags can be interacted with in close proximity, such as during their manufacture in a web format, because the tag selector dictates which tag(s) are enabled at any one time.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a plan view of an example radio frequency identification (RFID) tag.

FIG. 2 shows a plan view of an example web of tags that is a continuous roll type.

FIG. 3 shows an example block diagram of a tag interaction system, according to an embodiment of the present invention.

FIG. 4 shows a flowchart providing a process for interacting with tags, according to an example embodiment of the present invention.

FIGS. 5-7 show example types of tags, according to embodiments of the present invention.

FIG. 8 shows an example web-based tag interaction system, according to an embodiment of the present invention.

FIGS. 9-15 show example types of sensors and selector elements, according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to the testing of radio frequency identification (RFID) tags. According to embodiments of the present invention, a function of a tag is enabled by stimulation of a sensor of the tag. The enabled tag can be interacted with. For example, the tag can be tested, programmed, killed, interrogated, or otherwise processed or operated on. Other surrounding tags have not been stimulated, and thus do not respond to the attempts to interact with the tag. In this manner large numbers of tags in close proximity can be processed, such as during their manufacture in a web format, because only a selected tag is enabled at any one time.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Tag Selection and Interaction Embodiments

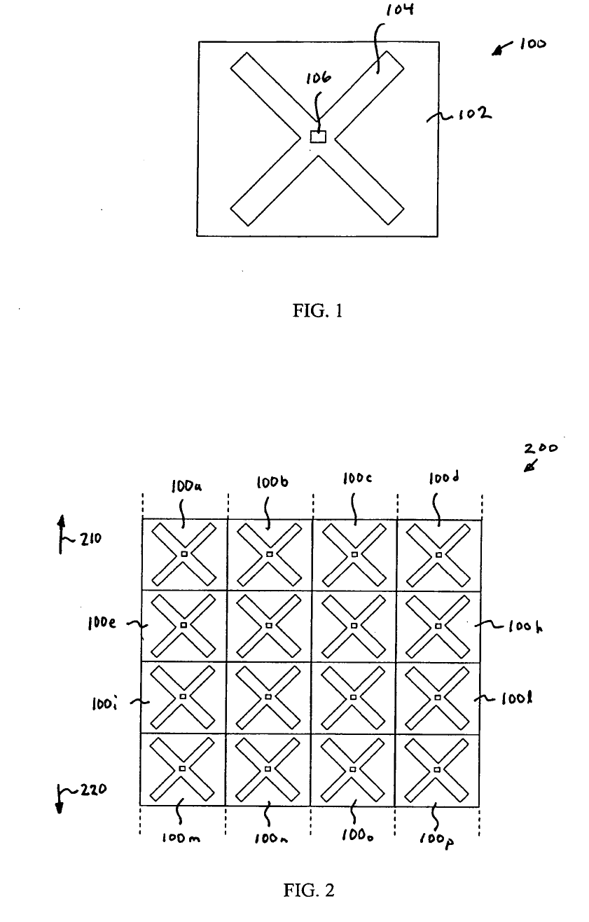

The present invention is applicable to any type of RFID tag. FIG. 1 shows a plan view of an example radio frequency identification (RFID) tag 100. Tag 100 includes a substrate 102, an antenna 104, and an integrated circuit (IC) 106. Antenna 104 is formed on a surface of substrate 102. Antenna 104 may include any number of one or more separate antennas. IC 106 includes one or more integrated circuit chips/dies, and can include other electronic circuitry. IC 106 is attached to substrate 102, and is coupled to antenna 104. IC 106 may be attached to substrate 102 in a recessed and/or non-recessed location. IC 106 controls operation of tag 100, and transmits signals to, and receives signals from RFID readers using antenna 104. Tag 100 may additionally include further elements, including an impedance matching network and/or other circuitry. The present invention is applicable to tag 100, and to other types of tags, including surface wave acoustic (SAW) type tags.

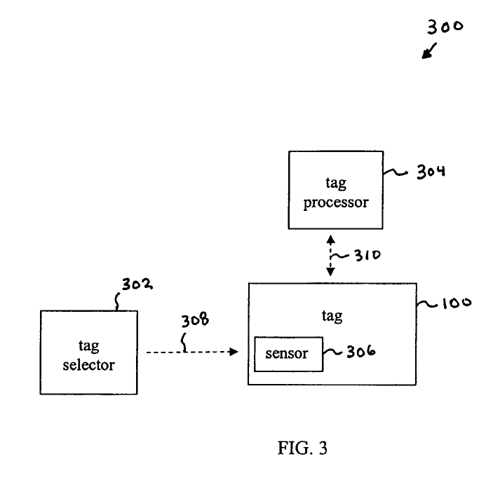

Volume production of RFID tags, such as tag 100, is typically accomplished on a printing web based system. For example, in such a system, the tags are assembled in a web of substrates, which may be a sheet of substrates, a continuous roll of substrates, or other grouping of substrates. For instance, FIG. 2 shows a plan view of an example web 200 that is a continuous roll type. As shown in FIG. 2, web 200 may extend further in the directions indicated by arrows 210 and 220. Web 200 includes a plurality of tags 100a-p. In the example of FIG. 2, the plurality of tags 100a-p in web 200 is arranged in a plurality of rows and columns. The present invention is applicable to any number of rows and columns of tags, and to other arrangements of tags.

On a web, such as web 200, RFID tags are typically assembled/positioned as close to each other as possible to maximize throughput, thus making the process of reading, programming, killing, and/or testing individual tags difficult. For example, it may be desired to program a tag, such as writing an identification number and/or other data to the tag. Furthermore, it may be desired to run a test algorithm for the tag to test its operation. Because of the close spacing in web 200, it is very difficult to localize a radiated (e.g., radio frequency) reader field to excite only one tag.

According to embodiments of the present invention, a tag selection configuration is used to select individual tags, even for tags positioned in close quarters, so that the selected tags can be interrogated, tested, programmed, killed, or otherwise interacted with, in a more reliable, secure, and repeatable fashion than in conventional schemes. In embodiments of the present invention, a tag selector interacts with a tag by stimulating a sensor of the tag.

Embodiments of the present invention are applicable to interacting with tags 100 in web 200. Tags may also be interacted with in other environments. In embodiments, tags may be interacted with in tag assembly/manufacture environments, in warehouse environments, in retail environments, etc.

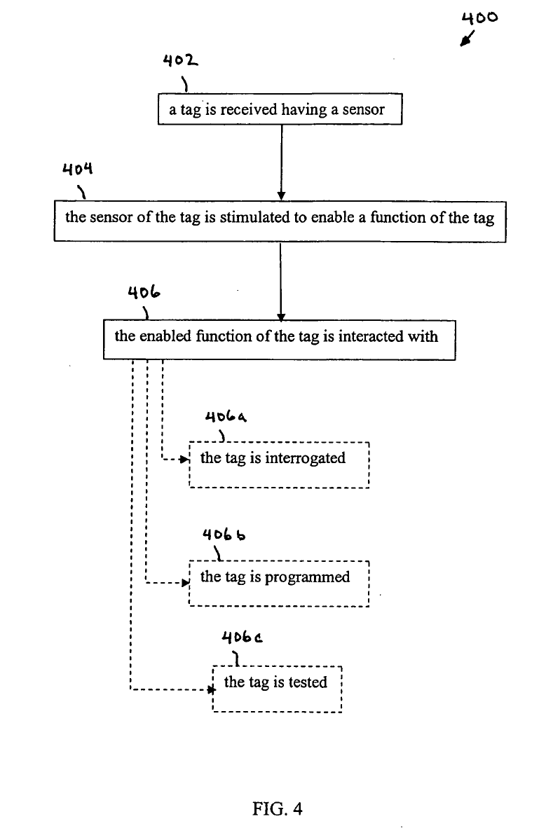

For example, FIG. 3 shows an example block diagram of a tag interaction system 300, according to an embodiment of the present invention. System 300 includes a tag selector 302 and a tag processor 304. As shown in FIG. 3, tag 100 includes a sensor 306. In embodiments, tag 100 can include any type of sensor, and any number of one or more sensors, as desired for the particular application. Example sensor types are described in detail further below.

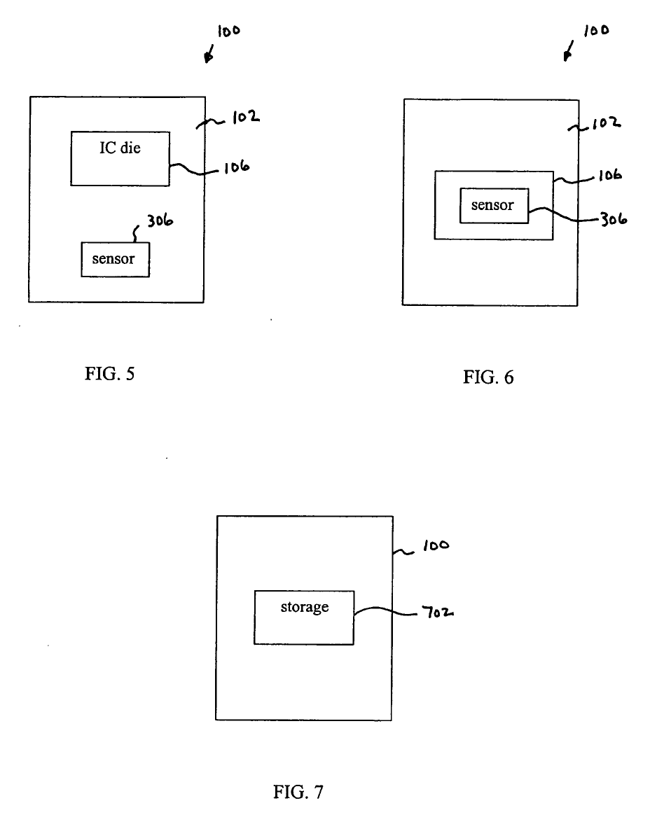

Example operation of system 300 is described with respect to FIG. 4. FIG. 4 shows a flowchart 400 providing example steps for interacting with tags, according to an example embodiment of the present invention. Other structural and operational embodiments will be apparent to persons skilled in the relevant art(s) based on the following discussion related to flowchart 400.

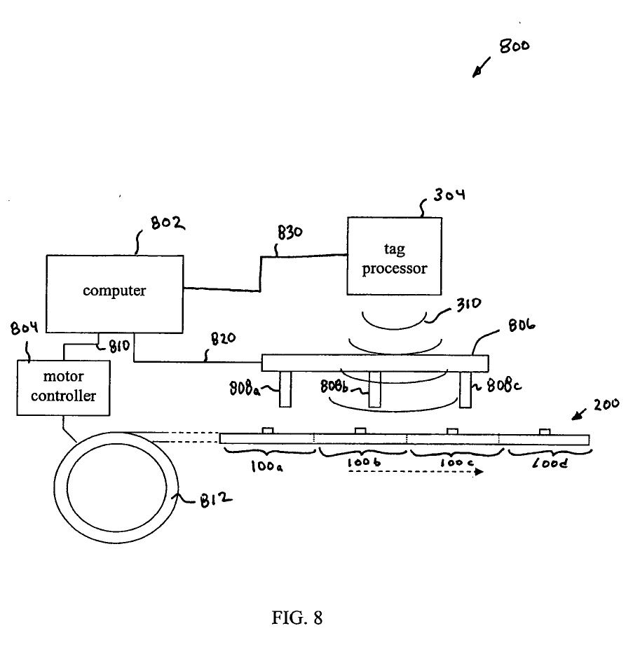

Flowchart 400 begins with step 402. In step 402, a tag is received having a sensor. For example, the tag is tag 100 shown in FIG. 1. As shown in FIG. 3, tag 100 includes sensor 306. Sensor 306 can be present anywhere in tag 100. For example, as shown in FIG. 4, sensor 306 can be mounted to, or otherwise formed in or on substrate 102 of tag 100. Alternatively, sensor 306 can be formed in or on IC die 106, as shown in FIG. 5.

In step 404, the sensor of the tag is stimulated to enable a function of the tag. For example, as shown in FIG. 3, tag selector 302 generates a tag sensor stimulus 308. Tag sensor stimulus 308 stimulates sensor 306 such that sensor 306 is activated, causing a functionality of tag 100 to be enabled. For instance, the stimulus to sensor 306 may change an electrical and/or mechanical feature (e.g., make or break an electrical connection) of tag 100, to turn on or off an applicable portion of tag 100 to enable the function. For example, the functionality may be a program module of tag 100 that relates to the programming of an identification number and/or other data into tag 100. In another example, the functionality that is enabled may be a “kill” function of tag 100, as further described below. In still another example, the full functionality of tag 100 is enabled, such that tag 100 may be interrogated and/or tested. According to embodiments, any portion of the functionality of tag 100 may be configured to be enabled by sensor 306, depending on the particular application.

In step 406, the enabled function of the tag is interacted with. In other words, the functionality of tag 100 enabled by stimulus of sensor 306, may be interacted with, including partial or full functionality of the tag. As shown in FIG. 304, tag processor 304 may be used to interact with the enabled function. Tag processor 304 generates tag interaction signal 310. Tag interaction signal 310 is shown as bi-directional in FIG. 3, but may also be unidirectional. Tag interaction signal 310 interacts with the enabled function of tag 100. Steps 406a-406c shown in FIG. 4 provide examples of how tag interaction signal 310 may interact with tag 100.

For example, as shown in FIG. 4, step 406 may include interrogating the tag, as in step 406a. Thus, for example, tag processor 304 may include RFID reader functionality to read an identification number stored in tag 100, and/or to otherwise interrogate tag 100. As shown in FIG. 7, tag 100 may include storage 702. Storage 702 may reside in IC die 106 or elsewhere in or on tag 100. Step 406a can be performed to verify a portion or all of an identification number and/or other data stored in storage 702 of tag 100.

In another example, step 406 may include programming the tag, as in step 406b. Thus, for example, tag processor 304 may include functionality to write an identification number and/or other data into storage 702 of tag 100. Thus, in an embodiment, tag processor 304 may include a programming module, having the hardware, software, and/or firmware necessary to program tags.

In another example, step 406 may include testing the tag, as shown in step 406c. Thus, for example, tag processor 304 may include functionality to perform a partial or full diagnostic test of tag 100. Thus, in an embodiment, tag processor 304 may include a test module, having the hardware, software, and/or firmware necessary to test tags.

In another example, step 406 may include killing the tag. For example, in step 404, tag selector 302 stimulates sensor 306, such that sensor 306 enables a “kill” functionality of tag 100. When the kill functionality is enabled, tag 100 may be killed (e.g., be made unable to be communicated with) by a kill signal. For example, when an item attaching tag 100 is sold in a retail environment, it may be desired to kill tag 100 so that it is no longer operational. This may be done to address privacy concerns, so that tag 100 cannot be later read. Thus, at a checkout area, for example, tag 100 may be brought near tag selector 302, to enable the kill functionality. Then, before the item leaves the store, a kill signal source (e.g., tag processor 304) can be used to kill tag 100 that has the kill functionality enabled. In this manner, tags in the vicinity that are not desired to be killed are not accidentally killed by the kill signal source, and only tags associated with items that have been sold are killed.

In another example, step 404 may include enabling a communication functionality of the tag, such as after a kill signal source has previously killed the tag. Thus, tag selector 302 stimulates sensor 306 to enable a killed tag 100 to communicate. In this manner, a previously killed tag 100 could be re-used. For example, in step 406, the tag could be re-programmed, etc., in a warehouse, by a person at home who purchased an item having the killed tag attached thereto, etc.

In an embodiment, once the tag selector stimulus is no longer applied to the tag sensor, the function of the tag is no longer enabled. Subsequently, a next tag can be enabled through application of the stimulus. Furthermore, an entity, such as tag processor 304, can interact with the enabled next tag. This interaction with the next tag can be performed without interference from the prior tag, which is no longer enabled.

Alternatively, in an embodiment, after a tag selector stimulus is applied to a tag, the tag is changed to and remains in the enabled state. Thus, in this alternative embodiment, the transition of the tag to the enabled state is permanent. In alternative to this embodiment, a second application of the stimulus can be used to disable the tag once again. Thus, in this embodiment, the tag selector stimulus can be used to toggle a tag between enabled and disabled states. For example, in a possible application, the tag selector stimulus could be applied to each tag twice, to temporarily enable and disable each tag in a web of tags for interaction therewith (e.g., programming, testing, killing, and/or communicating), and subsequently the tag selector stimulus could be applied a third time to each tag to permanently enable the tags to be used in the field once they leave the interaction station. Other mechanisms may be used to enable tags leaving the interaction station for operation in the field, as would be known to persons skilled in the relevant art(s) from the teachings herein. For example, in an embodiment, after testing, programming, etc., the sensor functionality of the tags could be killed by a kill signal or stimulus, to leave the tags permanently in the enabled state.

Thus, tag processor 304 can interact with enabled functions of tag 100 in the manners described above, elsewhere herein, and in any other way. Tag selector 302 and tag processor 304 each include software, hardware, and/or firmware, or any combination thereof, for selecting and interacting with tags, respectively. Tag selector 302 and tag processor 304 may be incorporated together into a computer system. Tag selector 302 and/or tag processor 304 can further include one or more storage devices for storing information regarding system 300 and tags being interacted with, including memory components, disc-based storage, magnetic storage devices, optical storage, etc. Furthermore, tag selector 302 and/or tag processor 304 can together or separately include a user interface, such as including a keyboard, display, graphical user interface (GUI), pointing device, and/or other visual and/or audio indicators, for a user to interact with tag selector 302 and/or tag processor 304 as needed.

In embodiments, tag processor 304 generates one or more interrogation signals or test signals to test tags. For example, test controller 302 may communicate with a tag according to any RFID communication protocol. Tag processor 304 may generate the signal(s) according to one or more interrogation/read protocols, as would be known to persons skilled in the relevant art(s), to read/communicate with tags under test. Example such protocols include binary protocols, tree traversal protocols, slotted aloha protocols, and those required by the following standards: Class 0; Class 1; and EPC Gen 2. Any future developed communication algorithms/protocols are also within the scope and spirit of the present invention.

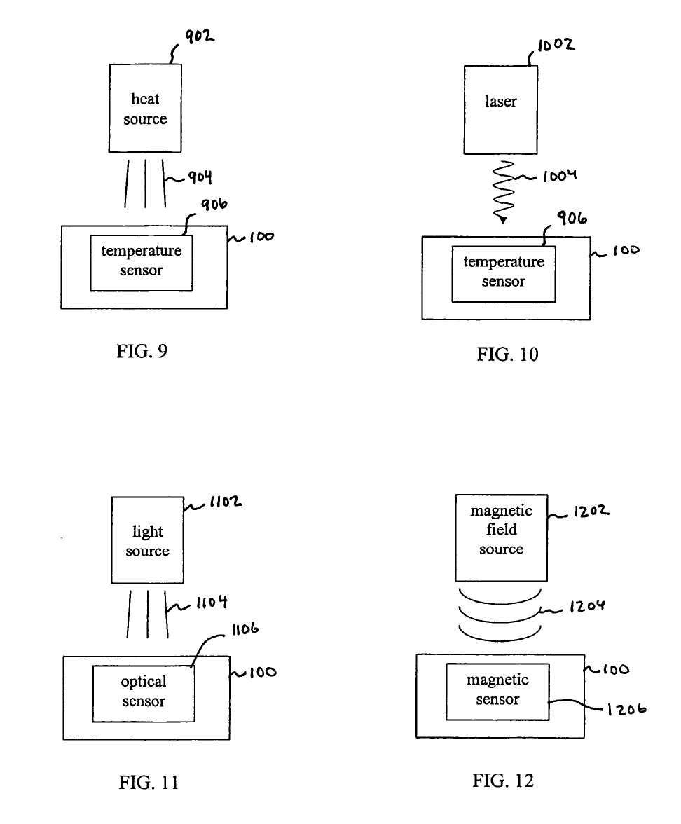

As described above, the tag processors described herein can include elements of conventional RFID readers. For example, depending on the particular application, a tag processor may incorporate one or more antennas, power controls, and read and write capabilities of an RFID reader, to conduct the interrogation and/or testing of tags. For instance, example conventional readers having features that are applicable to the embodiments of the present invention include AR400 and XR400 readers sold by Symbol Technologies of Holtsville, N.Y. The AR400 and XR400 are example 4-port readers that may be used in a “multi-channel” testing configuration, such as shown in FIG. 8, described further below. Such readers include also reader/printers, such as manufactured by Zebra Technologies Corporation of Vernon Hills, Illinois, and others, that combine tag programming with label printing. Handheld readers are also included, such as sold by Symbol Technologies and others.

An enabled tag 100 processes tag interaction signal 310 received from tag processor 304. The enabled tag 100 generates a corresponding response if appropriate (e.g., when being tested and/or interrogated). Tag processor 304 evaluates the response of tag 100 to determine whether the enabled function responded properly (if a response is expected).

For example, in a test interaction, tag processor 304 may evaluate the response of tag 100 to determine whether tag 100 is operating properly. For instance, the test signal(s) of tag processor 304 may have interrogated tag 100 for its identification number. Test controller 302 evaluates whether tag 100 properly responded with its identification number. In further embodiments, data other than the identification number can be read from tag 100, to test other data, storage elements, and/or features of tag 100. In embodiments, any type of test may be performed, to test any feature, parameter, characteristic, etc., of tag 100.

If during an example test, the identification number is properly received from tag 100 (and/or the tag otherwise responds properly), tag processor 304 determines that tag 100 has passed the test, and tag 100 can proceed accordingly. For example, in an embodiment, tag processor 304 may provide an indication that tag 100 passed the test by illuminating an indicator light, by displaying test result information on a graphical display, by storing test result information in storage, and/or by taking other action (or no action).

If the identification number is improperly received (and/or the tag otherwise responds improperly), tag processor 304 determines that tag 100 did not pass the test, and may not be functioning properly. For example, an improperly functioning tag may generate a response that is incorrect (i.e., is not the response expected from the tag for the particular test being performed, including a non-response). In such a situation, tag processor 304 may provide an indication that tag 100 failed the test by marking tag 100 as defective, by illuminating an indicator light, by displaying test result information on a graphical display, by storing the test result information in storage, and/or by taking other action. In this manner, the failed tag 100 can subsequently be repaired, disposed, or recycled.

In embodiments, any number of interactions can be performed with a particular tag, as long as the tag is enabled. Furthermore, in embodiments, multiple tags received in parallel may be interacted with according to embodiments. For example, FIG. 8 shows a web-based system 800, according to an embodiment of the present invention. As shown in FIG. 8, system 800 includes tag processor 304, a computer 802, a motor controller 804, a selector mount 806, and one or more selector elements 808. Three selector elements 808a-c are shown in FIG. 8 for illustrative purposes. However, any number of one or more selector elements 808 may be present, depending on the particular application.

In embodiments, system 800 may be incorporated into a tag assembly line (TAL), which may be a partially or fully automated assembly line. In the example of FIG. 8, a tag assembly line receives a continuous roll 812 of substrates, as web 200. Web 200 includes a plurality of substrates arranged in an array. Web 200 has a width in the X-direction (i.e., into the paper of FIG. 8) that is one or more substrates across. Web 200 has a length in the Y-direction that is substantially continuous (e.g., the length of a roll), and typically many substrates long. At one or more locations (not shown in FIG. 8) of the assembly line prior to a tag interaction station, dies 106 are applied to the substrates of web 200, and further tag assembly may occur, to produce tags 100 in web 200.

Once tags 100 have been assembled in web 200 to the extent that they are functional, they can be interacted with using system 800, for programming, test, etc. Computer 802 is coupled through a communications link 810 to motor controller 804. Computer 802 provides control signals to control operation of motor controller 804 over communications link 810, and may receive feedback from motor controller 804 over communications link 810, if appropriate for a particular application. Motor controller 804 causes roll 812 and/or further wheels and/or spools coupled to web 200 to advance web 200.

In the embodiment of FIG. 8, computer 802 and sensor elements 808 include functions of tag selector 302 of FIG. 3 further described above. Computer 802 is coupled to selector mount 806 through a communications link 820. Selector mount 806 is a mount for a plurality of selector elements 808a-808c. Selector elements 808a-808c are each configured to provide a stimulus (similar to tag sensor stimulus 308 described above) to a corresponding tag of web 200, when instructed by computer 802. Typically, a single one of selector elements 808 provides a stimulus at any one time, so that one tag is interacted with at a time, but multiple simultaneous stimuli are possible in some embodiments (e.g., when shielding is used to shield individual tags on the web, etc.). Note that although selector elements 808 are shown being applied to a top side of web 200 in FIG. 8, alternatively, selector elements 808 could be applied to a bottom side of tags 100 of web 200.

A single width row of selector elements 808 can be present to operate on a row of tags 100 of web 200, or a two-dimensional array of selector elements 808 can be present in system 800, to operate on a multiple rows of tags 100 web 200. Web 200 can be periodically or continuously advanced, such that subsequent rows of tags can be operated on in a similar fashion by selector elements 808. This process can continue until interaction with all the tags of web 200 is complete.

Alternatively, a single selector element 808 may be present in system 800. In such an embodiment, the single selector element 808 may be directed (e.g., aimed) or moved (e.g., by selector mount 806) as needed to operate on tags 100 at different positions on web 200. For example, in a laser selector embodiment, a scanning laser could be used (e.g., to provide a heat pulse), enabling tags one at a time on web 200 by being sequentially aimed at the tags.

Computer 802 is coupled to tag processor 304 through a communications link 830. Tag processor 304 is configured to provide tag interaction signal 310, under control of computer 802, to interact with a particular tag 100 of web 200 that is enabled by a sensor element 308. If appropriate, tag processor 304 is configured to receive responses from the particular tag 100 being interacted with. Tag processor 304 may radiate tag interaction signal 310 to a tag through the air, as shown in FIG. 8, or may make indirect or direct contact with the tag, depending on the particular application.

Computer 802 uses selector elements 808 to sequentially stimulate each tag 100 of web 200, one at a time, to sequentially enable a function of each tag 100. Tag processor 304 sequentially interacts with each stimulated tag 100 to interact with the tag function while enabled. In this manner, system 800 allows separate interaction with each of tags 100 of web 200.

Once tags 100 are interacted with (e.g., programmed and tested), further processing may be performed on tags 100, including processing tags 100 into label format, singulation of web 200 into separate tags, removal of failed tags, etc.

Note that selector mount 806 of FIG. 8 is shown for illustrative purposes, and that any type of mount may used, as would be understood by persons skilled in the relevant art(s), including individual mounts for each selector element, etc.

System 800 is shown for illustrative purposes, and not for purposes of limitation. Embodiments of the present invention may be implemented in a variety of systems. For example, label printers exist that print a bar code label, while programming a RFID tag embedded in the label. In such an application, the label printer (hand-held or otherwise) may include a selector element 808, such as a heating head, that is pulsed to enable programming of the tag of a label currently being spooled and printed. Thus, a label currently being spooled over a test head of the label printer can be tested without impacting other tags on the label spool. Further systems and applications for selection and interaction with tags will become known to persons skilled in the relevant art(s) from the teachings herein.

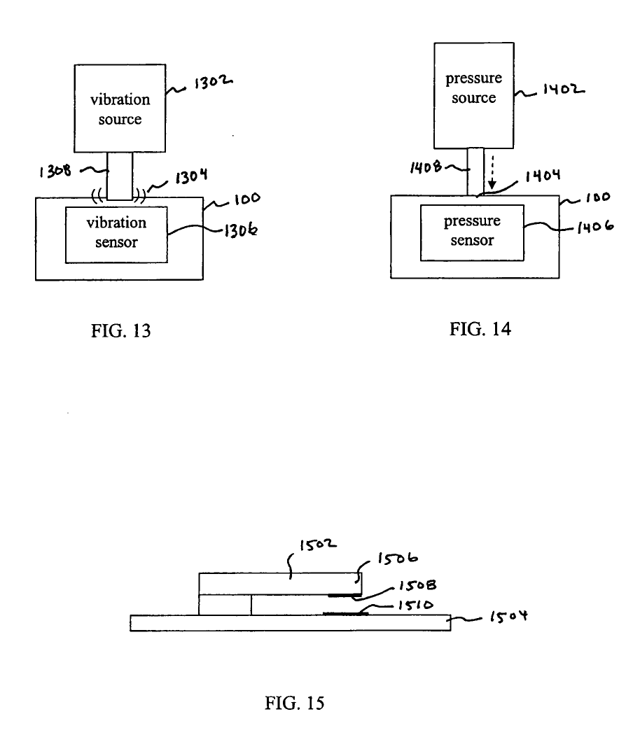

As described above, a variety of types of sensors 306 may be present in tags 100. Thus, various corresponding types of selector elements 808 may be used to produce a corresponding tag sensor stimulus 308 to stimulate the sensors. FIGS. 9-15 show example types of sensors 306 and corresponding selector elements 808, according to embodiments of the present invention.

FIG. 9 shows tag 100 including a temperature sensor 906. In FIG. 9, selector element 808 is a heat source 902 that applies heat 904 to temperature sensor 906 to stimulate temperature sensor 906. Heat source 902 can be any heat source, including a source of radiated heat and conducted heat, including a heated head, or a hot gas flow nozzle. In another example, heat source 902 may be a laser 1002, such as shown in FIG. 10. As shown in FIG. 10, laser 1002 (such as a low power laser) emits a laser beam 1004 used to heat temperature sensor 906, to stimulate temperature sensor 906. Temperature sensor 906 can be any type of component or material that suitably changes a measurable characteristic with temperature, including a thermistor, a metal (e.g., expands (has a suitable coefficient of thermal expansion, CTE), changes in electrical conductivity, etc.) or other material. In an example embodiment, temperature sensor 906 can be a temperature gradient sensing device in IC die 106 that detects a small but sudden rise in temperature from a heating head of heat source 902.

FIG. 11 shows tag 100 including an optical sensor 1106. In FIG. 11, selector element 808 is a light source 1102 that emits light 1104 to optical sensor 1106 to stimulate optical sensor 1106. Light source 1102 can be any type of applicable light source, including a light bulb, light emitting diode, laser, etc. In example embodiments, optical sensor 1106 can be one or more photodetectors, such as semiconductor photodiodes or phototransistors that are fabricated into IC die 106.

FIG. 12 shows tag 100 including a magnetic sensor 1206. In FIG. 12, selector element 808 is a magnetic field source 1202, such as a magnet (including an electromagnet) that generates a magnetic field 1204 to stimulate magnetic sensor 1206. Magnetic sensor 1206 can include any type of material that suitably changes a measurable characteristic in a magnetic field, including a Hall effect device, a metal (e.g., that bends), permalloy, or other material.

FIG. 13 shows tag 100 including a vibration sensor 1306. In FIG. 13, selector element 808 is a vibration source 1302, that may include a contact member 1308 for making contact with tag 100, that generates a vibration 1304 to stimulate vibration sensor 1306. For example, vibration source 1302 can be any source that can provide any suitable vibration frequencies, including ultrasound frequencies. Vibration sensor 1306 can be any type of vibration sensor, including a piezo-electric membrane, a micro-electrical-mechanical system (MEMS) element fabricated into IC die 106 or otherwise formed on or mounted to tag 100, or any other type of vibration sensor, including an ultrasonic sensor.

FIG. 14 shows tag 100 including a pressure sensor 1406. In FIG. 14, selector element 808 is a pressure source 1402 that provides a pressure 1404 to stimulate pressure sensor 1406. Pressure source 1402 may be any type of pressure source, and may include a contact member 1408 for making contact with tag 100 (as shown in FIG. 14), a gas source to apply a directed gas pressure, etc. Pressure sensor 1406 can be any type of pressure sensor, including a strain gauge, a piezo-electric sensor, a switch, etc.

Note that contact members 1308 and 1408, when present, may include a spring and/or other shock-absorption mechanism, to prevent damage to tag 100 when they make contact therewith.

FIG. 15 shows a cross-sectional view of a MEMS cantilever 1502 formed in or on a substrate 1504, which may be die 106, substrate 102, or other portion of tag 100. Cantilever 1502 may be used as vibration sensor 1306 or pressure sensor 1406. For example, when cantilever 1502 is vibrated, or when sufficient pressure is applied to cantilever 1502, an end 1506 of cantilever may make contact with substrate 1504 to activate the sensor. For instance, a contact area 1508 on end 1506 of cantilever 1502 may be an electrically conductive material that makes electrical contact with a contact area 1510 on substrate 1504 when cantilever 1502 bends, to create an electrical current path, thereby allowing cantilever 1502 to operate as a switch. Cantilever 1502 can be formed in a variety of ways, including standard photolithography and other MEMS fabrication techniques.

In embodiments, the tag selection techniques described herein allow interaction with tags in an independent and sequential manner. The tag selection techniques also reduce the possibility of tags being read, re-programmed, or killed by unauthorized sources, because interaction with the tags requires application of the tag selector stimulus.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for interacting with one or more of a plurality of radio frequency identification (RFID) tags, wherein each tag includes a sensor, comprising:
stimulating a sensor of a tag to enable a tag function; and
interacting with the enabled function of the tag.

2. The method of claim 1, wherein the tag function is a tag programming function, wherein said interacting comprises:
programming the tag.

3. The method of claim 2, wherein said programming comprises:
writing an identification number into the tag.

4. The method of claim 1, wherein said stimulating comprises:
enabling full functionality of the tag.

5. The method of claim 1, wherein said interacting comprises:
testing the tag.

6. The method of claim 1, wherein the sensor is a temperature sensor, wherein said stimulating comprises:
applying heat to the sensor.

7. The method of claim 1, wherein the sensor is an optical sensor, wherein said stimulating comprises:
applying light to the sensor.

8. The method of claim 1, wherein the sensor is a magnetic sensor, wherein said stimulating comprises:
applying a magnetic field to the sensor.

9. The method of claim 1, wherein the sensor is a pressure sensor, wherein said stimulating comprises:
applying pressure to the sensor.

10. The method of claim 1, wherein the sensor is a vibration sensor, wherein said stimulating comprises:
applying vibration to the sensor.

11. The method of claim 1, wherein the sensor is an ultrasonic sensor, wherein said stimulating comprises:
applying ultrasound to the sensor.

12. The method of claim 1, further comprising:
repeating said stimulating and said interacting for each further tag of the plurality of tags to be tested.

13. A radio frequency identification (RFID) tag, comprising:
a substrate;
an antenna on the substrate;
an integrated circuit (IC) die mounted to the substrate; and
a sensor that when stimulated enables a function of the tag.

14. The tag of claim 13, wherein the sensor is a temperature sensor, an optical sensor, a magnetic sensor, a pressure sensor, or a vibration sensor.

15. The tag of claim 13, wherein the sensor is mounted to the substrate.

16. The tag of claim 13, wherein the IC die comprises the sensor.

17. The tag of claim 16, wherein the sensor enables a function of the IC die.

18. The tag of claim 13, wherein stimulation of the sensor enables a programming function of the tag.

19. The tag of claim 13, wherein stimulation of the sensor enables the IC die to function.

20. A system for interacting with a radio frequency identification (RFID) tag, comprising:
a tag selector that stimulates a sensor of a tag to enable a function of the tag; and
a tag processor that interacts with the enabled tag function.

21. The system of claim 20, wherein the tag one of a plurality of tags in a web.

22. The system of claim 22, further comprising:
a computer coupled to the tag selector and tag processor.

23. The system of claim 22, wherein the computer is coupled to a transport system for the web.

24. The system of claim 22, wherein the computer comprises a test module that includes a tag test algorithm.

25. The system of claim 22, wherein the computer comprises a programming module that includes a tag programming algorithm.

26. The system of claim 20, wherein the tag selector sequentially stimulates each tag of the web one at a time to sequentially enable a function of each tag of the web, and the tag processor sequentially interacts with each stimulated tag to interact with the tag function while enabled.

27. The system of claim 20, wherein the sensor is a temperature sensor, wherein the tag selector comprises a heat source that applies heat to the sensor to stimulate the sensor.

28. The system of claim 20, wherein the sensor is an optical sensor, wherein the tag selector comprises a light source that emits light to the sensor to stimulate the sensor.

29. The system of claim 20, wherein the sensor is a magnetic sensor, wherein the tag selector generates a magnetic field received by the sensor to stimulate the sensor.

30. The system of claim 20, wherein the sensor is a pressure sensor, wherein the tag selector applies pressure to the sensor to stimulate the sensor.

31. The system of claim 20, wherein the sensor is a vibration sensor, wherein the tag selector vibrates the sensor to stimulate the sensor.

32. The system of claim 20, wherein the sensor is an ultrasound sensor, wherein the tag selector applies ultrasound to the sensor to stimulate the sensor.
